(19) United States
(12) Patent Application Publication
(10) Pub. No.: US 2014/0328985 A1
(43) Pub. Date: Nov. 6, 2014

(54) UV LIQUID STERILISER

(71) Applicant: Malcolm Robert Snowball, Essex (GB)

(72) Inventor: Malcolm Robert Snowball, Essex (GB)

(73) Assignee: STERIFLOW LIMITED, Northhamptonshire (GB)

(21) Appl. No.: 14/343,692

(22) PCT Filed: Aug. 30, 2012
(86) PCT No.: PCT/GB2012/052123

§ 371 Date: Jun. 5, 2014

(30) Foreign Application Priority Data
Sep. 9, 2011 (GB) 1115616.3

(51) Int. Cl. A23L 3/28; A23L 2/50

(52) U.S. Cl. CPC A23L 3/28; A23L 2/50; A23V 2002/00
USPC 426/248; 99/451

(57) ABSTRACT

A fluid steriliser comprising a fluid duct having a UV transmissive wall providing a surface area for irradiation, wherein the cross section of the duct is between 1×10⁻⁴ m² and 5×10⁻² m² and the thickness of the duct defines the depth of fluid flow adjacent the UV transmissive wall of no more than 50mm; a source of UV radiation arranged to irradiate fluid flowing in the duct through the UV transmissive wall such that the UV radiation incident on fluid in the duct has a UV power density; a plurality of mixing stages configured to provide turbulent flow in the fluid and spaced apart along the length of the duct wherein the segments of the duct between the mixing stages are arranged to provide flow adjacent the UV transmissive wall; a flow control means arranged to control the linear speed of fluid flow along the duct based on the length of the duct and the UV power density so that at least 300 Joules of UV energy per square metre of the surface area for irradiation is provided to the fluid during the dwell time of the fluid in the duct.

This invention relates to methods and apparatus for disinfecting fluids and, in particular to methods and apparatus for disinfecting drinks and comestible fluids such as syrups and concentrates.

To ensure that all of a fluid is properly irradiated, disinfection using ultra-violet (UV) radiation requires that the fluid be extremely thinly dispersed and/or that it be very thoroughly mixed during irradiation. To achieve practical rates of volume throughput for industrial processes whilst meeting the required standards for disinfection rates (5-Log kill or better) had been thought technically difficult to achieve using UV methods. Our previous International Patent Application, publication number WO2010/125389 discloses an advantageous method and system for achieving this.

We have recognised a problem that comestible fluids differ substantially in their flow properties and interaction with UV light. We have further recognised that it is desirable to minimise both the UV power applied and the irradiation time to increase the energy efficiency and volume throughput of a commercial processing plant. It had previously been thought that passing fluids through UV disinfection apparatus at excessive speed would reduce efficacy by reducing irradiation time. However we have now shown that, dependent on the characteristics of the fluid efficient flow and acceptable disinfection rates are achievable. We have also now recognised that certain liquids are prone to growths of agglomerations (clumps) of micro organisms and that the organisms at the centre of these clumps may bypass a conventional disinfector unharmed but we have dealt with this issue.

After further work we have demonstrated that gains in efficiency and the rate of disinfection can be achieved by selecting particular dimensions and flow rates for particular fluids without needing to increase the overall size or power of the apparatus. This selection enables relatively low power apparatus to achieve (and exceed) commercially acceptable disinfection standards whilst providing sufficient throughput to meet operational need in industrial food preparation facilities. Without wishing to be bound by theory it is thought that, if turbulent flow in a thin film can be achieved, high shear stresses in the fluid exist which promote the disintegration of agglomerations of microorganisms enabling these organisms to be more properly exposed to UV radiation.

We present herein a series of examples to demonstrate the efficacy of our new methods and of apparatus constructed according to the principles demonstrated herein.

In an aspect there is provided a fluid steriliser comprising a plurality of units coupled in parallel between a common fluid source and a common fluid outlet, each unit comprising: a fluid duct having a UV transmissive wall providing a surface area for irradiation, wherein the cross section of the duct is between 1×10⁻⁴ m² and 1×10⁻³ m² and the thickness of the duct defines the depth of fluid flow adjacent the UV transmissive wall; a source of UV radiation arranged to irradiate fluid flowing in the duct through the UV transmissive wall such that the UV radiation incident on fluid in the duct has a UV power density; a plurality of mixing stages configured to provide turbulent flow in the fluid and spaced apart along the length of the duct wherein the segments of the duct between the mixing stages are arranged to provide at least partially laminar flow adjacent the UV transmissive wall; a flow control means arranged to control the linear speed of fluid flow along the duct based on the length of the duct and the UV power density so that at least 300 Joules of UV energy per square metre of the surface area for irradiation is provided to the fluid during the dwell time of the fluid in the duct. This and other examples of the invention have the advantage of providing effective cold sterilisation of comestible fluids in practical commercial systems.

In some examples the mixing stages comprise UV transmissive material. Preferably wherein the mixing stages are arranged so that UV light from the UV source can reach the interior surfaces of the mixing stages when the mixing stage is filled with a UV transmissive fluid. This has the advantage that, when the mixing stages are filled with a UV transmissive fluid, such as cleaning water, the unit can be irradiated with UV light to sterilise the mixing stages.

In some possibilities the flow control means is configured such that, in use with fluids having a viscosity of less than 200 centipoise, the pressure drop across the fluid duct is less than 8 bar. In some possibilities the mixing stations comprise baffles arranged at an angle of at least 70° to the direction of the at least partially laminar flow adjacent the UV transmissive wall. Preferably the flow control means is configured to control the flow of fluid along the duct such that the average linear speed of the fluid flow between the baffles is between 0.6 and 1.8 meters per second, still more preferable between 1.0 meters per second and 1.4 metres per second. These and other examples of the invention have the advantage of providing effective mixing of fluids without modifying their texture or consistency in a manner which is noticeable to consumers.

In an aspect there is provided a fluid treatment apparatus comprising a plurality of mutually similar units, each unit comprising plurality of elongate tubular ducts, a fluid inlet in fluid communication with a fluid outlet via the plurality of elongate tubular ducts, each duct having:
a UV transmissive inner wall spaced from an outer wall to enable fluid flow along the tubular duct between the inner wall and outer wall;
a plurality of baffles distributed along the length of the duct and arranged substantially perpendicular to the direction of the fluid flow;
the apparatus further comprising a flow control means configured to control the flow of fluid along the duct such that the average linear speed of the fluid flow between the baffles is between 1.0 and 1.6 meters per second. We have surprisingly found that this range of linear speeds provides more effective disinfection for high volume throughput. Without wishing to be bound by theory it is believed that, at this range of linear speeds fluid mixing is enhanced without reducing the effectiveness of irradiation.

In one possibility the interior surface of the inner wall of the duct has a diameter of at least 38.5 mm. In one possibility the interior surface of the inner wall of the duct has a diameter of at least 39 mm. In one possibility the interior surface of the inner wall of the duct has a diameter of at least 39.5 mm. In one possibility the interior surface of the outer wall of the duct has a diameter of less than 54 mm. In one possibility the interior surface of the outer wall of the duct has a diameter of less than 52 mm. In one possibility the interior surface of the outer wall of the duct has a diameter of less than 51 mm. In one possibility the interior surface of the outer wall of the duct has a diameter of less than 50.5 mm.

In an aspect there is provided a method of disinfecting comestible fluid comprising providing fluid into a fluid treatment apparatus comprising an elongate tubular duct having:
a duct inlet, a duct outlet, and a UV transmissive inner wall spaced from an outer wall to enable fruit juice to flow along the tubular duct between the inner wall and outer wall, wherein the cross section of the duct through which fluid can flow has an area of at least 1×10⁻⁴ m² and less than 1×10⁻³ m²; a plurality of baffles distributed along the length of the duct and arranged substantially perpendicular to the direction of the flow;
irradiating the fluid through the UV transmissive wall with UV radiation;
controlling the pressure of the juice such that the pressure difference between the duct inlet and the duct outlet is less than 0.4 bar and more than than 0.05 bar. These examples of the invention have the advantage of improved disinfection of the fluid for a given irradiative power. This method has been found to be particularly effective in the disinfection of milk and fruit juices. Without wishing to be bound by theory it is thought that the consistency and UV transmitting characteristics of these fluids mean that under these pressure differentials through ducts of this size, very effective mixing is provided.

Preferably the cross section of the duct through which fluid can flow is at least 2×10⁻⁴ m², still more preferably the cross section of the duct through which fluid can flow is at least 3×10⁻⁴ m². In some possibilities the cross section of the duct is at least 4×10⁻⁴ m². In some possibilities the cross section of the duct is at least 6×10⁻⁴ m². Preferably the cross section of the duct through which fluid can flow is less than 9×10⁻⁴ m², still more preferably the cross section of the duct through which fluid can flow is less than 8×10⁻⁴ m². In some possibilities the cross section of the duct is less than 7.9×10⁻⁴ m².

In some possibilities the pressure difference between the duct inlet and the duct outlet is greater than 0.08 bar, preferably greater than 0.1 bar. In some possibilities the pressure difference between the duct inlet and the duct outlet is less than 0.2 bar, preferably less than 0.19 bar. In some possibilities a pressure difference of about 0.16 bar may be applied. These and other examples of the invention have the advantage of exceeding the commercially acceptable disinfection rates for fruit juices (better than 5 log kill).

In an aspect there is provided a method of disinfecting edible oils comprising providing edible oil into a fluid treatment apparatus comprising an elongate tubular duct having:
a duct inlet, a duct outlet, and a UV transmissive inner wall spaced from an outer wall to enable fluid to flow along the tubular duct between the inner wall and outer wall, wherein the cross section of the duct through which fluid can flow has an area of at least 1×10⁻⁴ m²; a plurality of baffles distributed along the length of the duct and arranged substantially perpendicular to the direction of the flow;
irradiating the juice through the UV transmissive wall with UV radiation;
controlling the pressure of the edible oil such that the pressure difference between the duct inlet and the duct outlet is greater than 0.9 bar and less than 1.7 bar, wherein the edible oil has a viscosity of at least 30 cP (mPa·s) and less than 70 cP (mPa·s). These examples of the invention have the advantage of improved disinfection of the oils for a given irradiative power.

Preferably the cross section of the duct through which fluid can flow is at least 2×10⁻⁴ m², still more preferably the cross section of the duct through which fluid can flow is at least 15 3×10⁻⁴ m². In some possibilities the cross section of the duct is at least 3.2×10⁻⁴ m². Preferably the cross section of the duct through which fluid can flow is less than 6×10⁻⁴ m², still more preferably the cross section of the duct through which fluid can flow is less than 5×10⁻⁴ m². In some possibilities the cross section of the duct is less than 3.4×10⁻⁴ m². In some possibilities the pressure difference between the duct inlet and the duct outlet is greater than 1.3 bar, preferably greater than 1.4 bar. In some possibilities the pressure difference between the duct inlet and the duct outlet is less than 1.7 bar, preferably less than 1.6 bar. These and other examples of the invention have the advantage of exceeding the commercially acceptable disinfection rates for oils (better than 5 log kill) In an aspect there is provided a method of disinfecting beer, milk or vinegar comprising providing milk into a fluid treatment apparatus comprising an elongate tubular duct having:
a duct inlet, a duct outlet, and a UV transmissive inner wall spaced from an outer wall to enable fluid to flow along the tubular duct between the inner wall and outer wall, wherein the cross section of the duct through which fluid can flow has an area of at least 1×10⁻⁴ m²; a plurality of baffles distributed along the length of the duct and arranged substantially perpendicular to the direction of the flow;
irradiating the juice through the UV transmissive wall with UV radiation;
controlling the pressure of the milk or vinegar such that the pressure difference between the duct inlet and the duct outlet is greater than 0.3 bar and less than 0.9 bar. These examples of the invention have the advantage of improved disinfection of the milk for a given irradiative power.

Preferably the cross section of the duct through which fluid can flow is at least 2×10⁻⁴ m², still more preferably the cross section of the duct through which fluid can flow is at least 3×10⁻⁴ m². In some possibilities the cross section of the duct is at least 3.2×10⁻⁴ m². Preferably the cross section of the duct through which fluid can flow is less than 6×10⁻⁴ m², still more preferably the cross section of the duct through which fluid can flow is less than 5×10⁻⁴ m². In some possibilities the cross section of the duct is less than 3.4×10⁻⁴ m². In some possibilities the pressure difference between the duct inlet and the duct outlet is greater than 0.4 bar, preferably greater than 0.5 bar, preferably the pressure difference is 0.62 bar for milk and 0.66 bar for vinegar.

In some possibilities the pressure difference between the duct inlet and the duct outlet is less than 0.8 bar, preferably less than 0.7 bar. These and other examples of the invention have the advantage of exceeding the commercially acceptable disinfection rates for milk and vinegar whilst reducing the power consumption of the apparatus per unit volume of fluid to be disinfected.

In accordance with the present disclosure there is provided a fluid treatment apparatus, comprising an elongate tubular duct having a fluid inlet and outlet at opposite ends thereof an elongate source of UV radiation extending longitudinally of said elongate tubular duct, and a mixing device disposed between adjacent longitudinal portions of the duct for diverting all of the fluid flowing along a first said portion of the duct through fluid mixing means in the device and for returning the mixed fluid to a second said portion of the duct.

The mixing of all the fluid ensures that all parts of the fluid come within sufficient proximity of the UV source.

Preferably said mixing means defines a tortuous flow path through which the fluid flows, the flow along the passage serving to provide a high degree of mixing.

Preferably the flow path comprises one of more turns of 90 degrees and preferably the flow passage turns the fluid though at least 180 degrees between adjacent longitudinal portions of the duct. Good mixing of a liquid can be achieved by continually changing its direction through 90 degree bends or preferably through 180 degree bends. The continual sudden velocity changes imparted to the liquid by this technique ensures all constituents of the liquid are mixed. Preferably at least a portion of the flow path is arranged to be irradiated by UV radiation emitted by said source.

Preferably the duct defines a flow passage for the fluid in which all of the fluid is no more than 10 mm and preferably no more than 5 mm away from the surface of the UV source, the source forming at least a portion of the longitudinal wall of the flow passage. In this way the fluid flows as a thin film over the UV source. The surface constituents of the thin film are continually being changed due to the mixing effect.

Preferably the UV source extends along the central axis of the duct and is surrounded by the flow passage.

Preferably the UV source comprises an elongate lamp disposed inside a tube which is preferably formed of quartz or another material which is a good transmitter of UV radiation.

Preferably the tube is coated or covered with a material arranged to maintain the integrity of the tube should it break, thereby preventing contamination of the fluid with potential harmful pieces of the tube material. Preferably the coating or covering material comprises fluorinated ethylene propylene.

Preferably a plurality of said devices are provided along the length of the duct so that the fluid is mixed more than once.

Preferably the inlet and outlet communicate with respective manifolds at opposite ends of the duct.

Preferably the UV source extends into one or both manifolds.

Also, in accordance with the disclosure, there is provided a fluid disinfection system comprising a plurality of the above-mentioned apparatus connected in series to increase the disinfection effect or in parallel to increase the flow rate of the disinfected fluid or both.

A summarisation of the disclosure and the benefits thereof is as follows:—Disinfection system with no moving parts—all parts may be stationary therefore the reliability of the system is high.

Room temperature (change to cold) disinfection system—the process is substantially a cold process.

Can withstand the industry cleaning pressures—all parts are able to withstand pressures of 10 bar and beyond.

Produces a consistent thin film of liquid—the gap between the quartz tube and the inner surface of the duct provides a consistent liquid film thickness.

Continually and thoroughly mixes the fluid

The mixing devices are placed at intervals along the length of the apparatus forcing the fluid to change direction and hence the fluid velocity ensuring constant and thorough mixing of the fluid as it flows through the system.

Embodiments of this invention will now be described by way of example only and with reference to the accompanying drawings, in which;

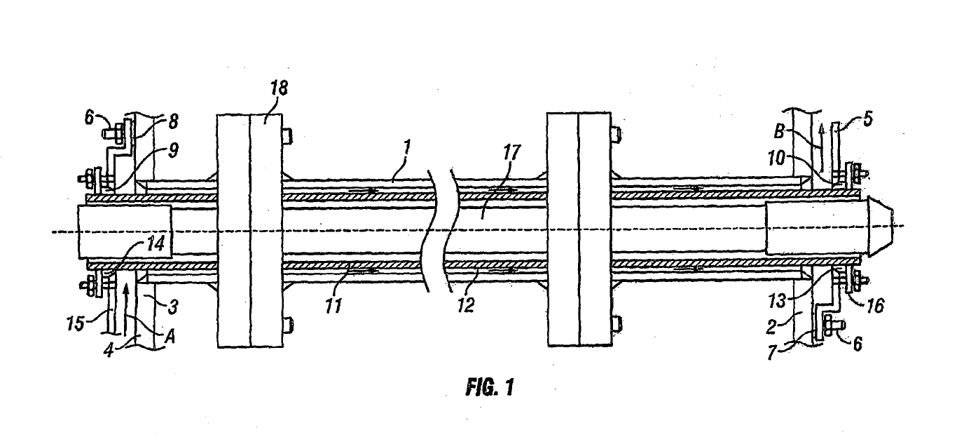

FIG. 1 shows a plan view with part section of a first embodiment of fluid disinfection apparatus;

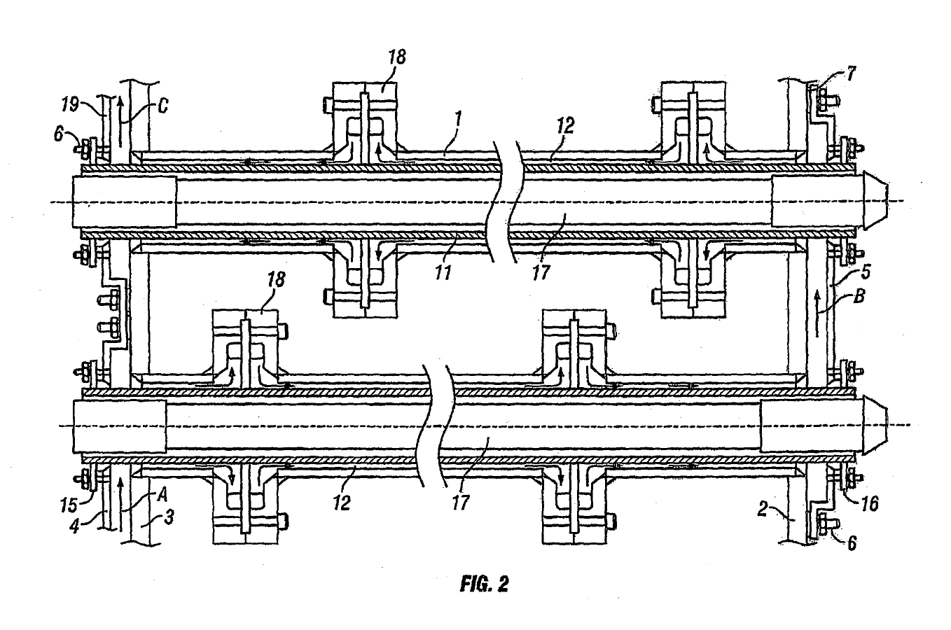

FIG. 2 shows a plan view with part section of a second embodiment of fluid disinfection apparatus;

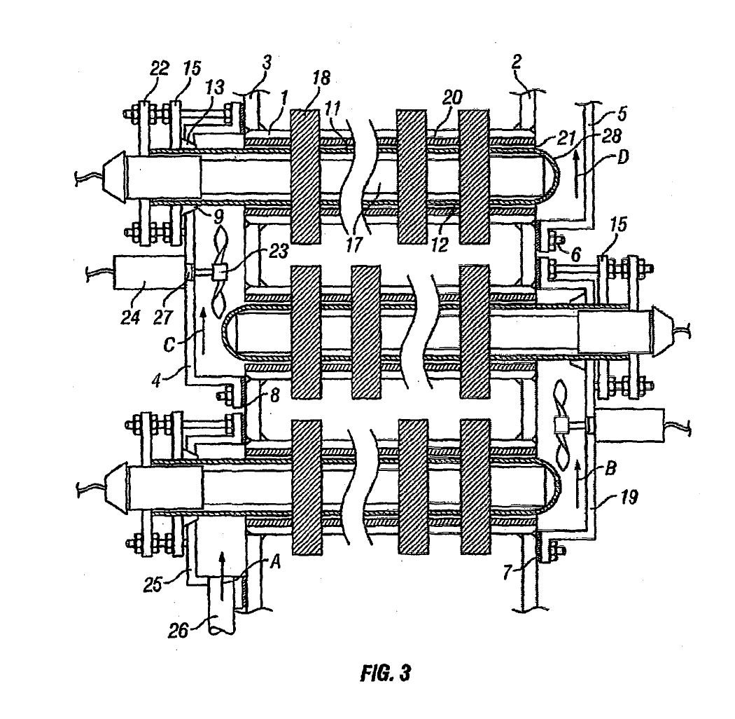

FIG. 3 shows a plan view with part section of a third embodiment of fluid disinfection apparatus;

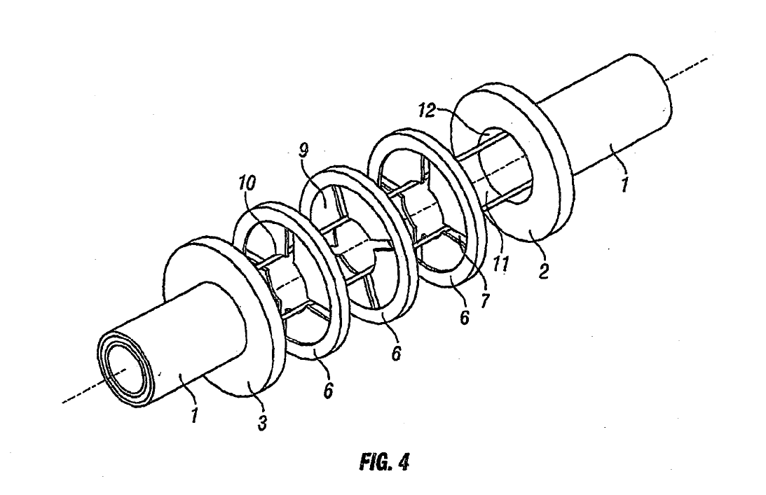

FIG. 4 shows an exploded view of a mixing device for a fluid disinfection apparatus;

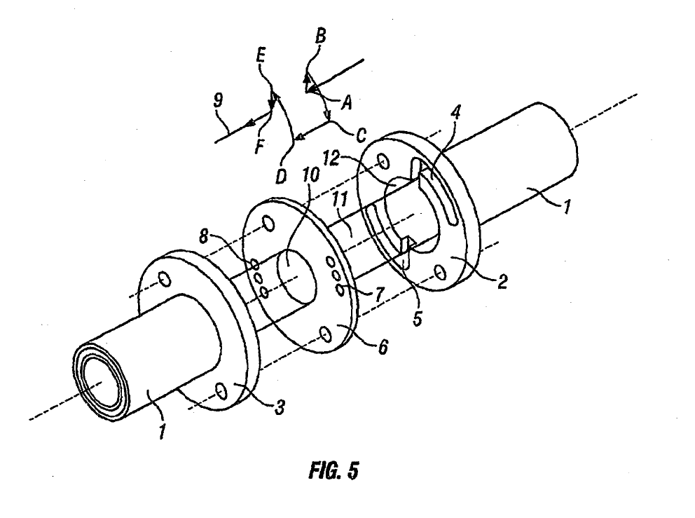

FIG. 5 shows an exploded view of a mixing device for a fluid disinfection apparatus;

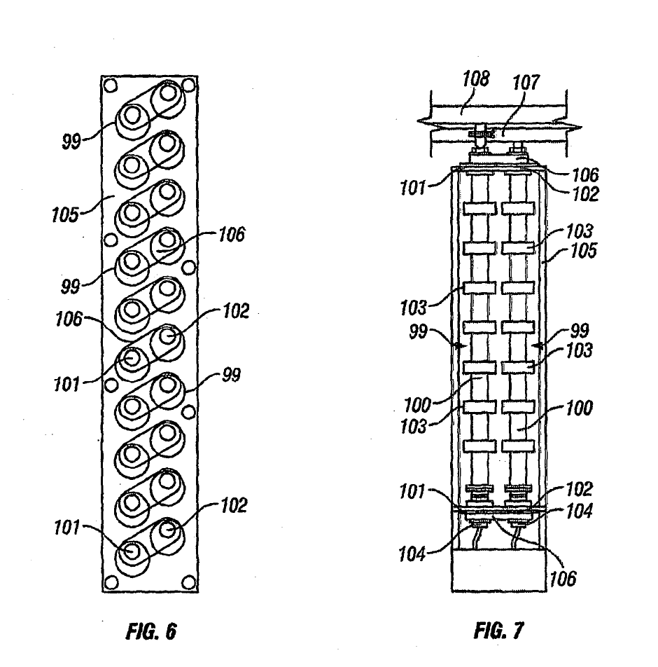

FIG. 6 shows a sectional view of a fluid disinfection apparatus in accordance with the invention;

FIG. 7 shows a plan view of the apparatus of FIG. 6;

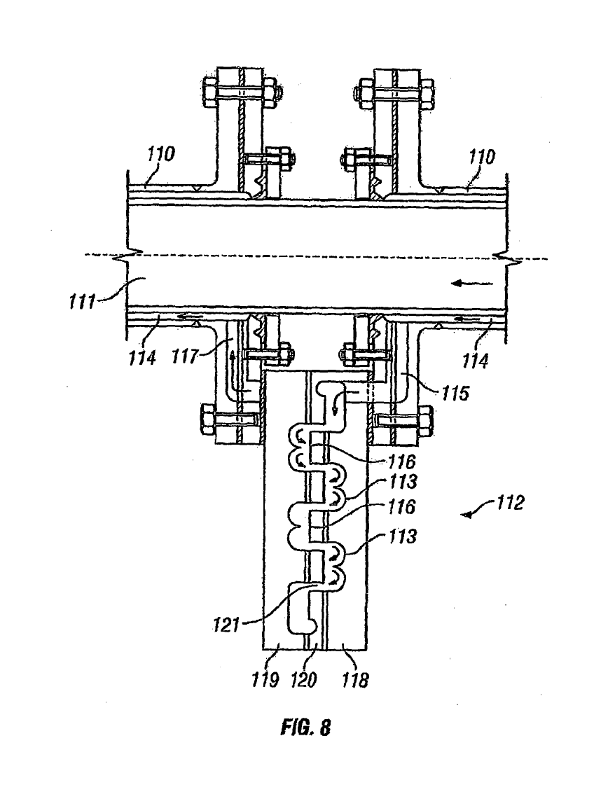

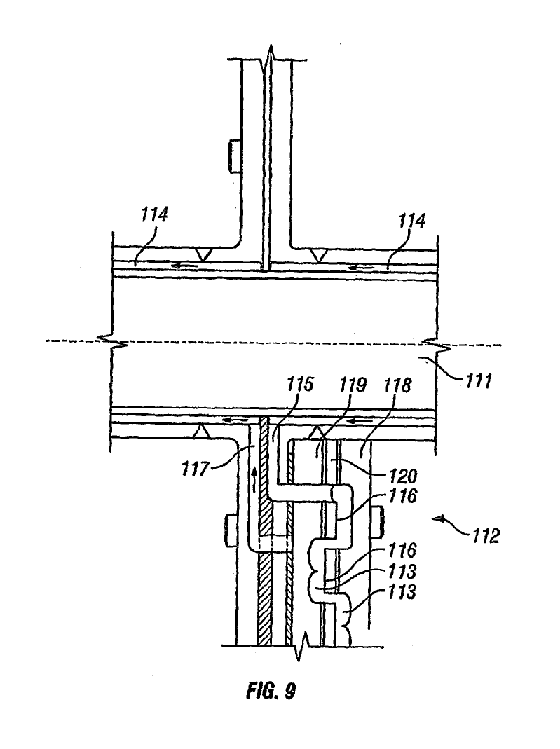

FIG. 8 shows an exploded view of a portion of a fluid disinfection apparatus;

FIG. 9 shows an exploded view of a portion of a fluid disinfection apparatus in accordance with the invention;

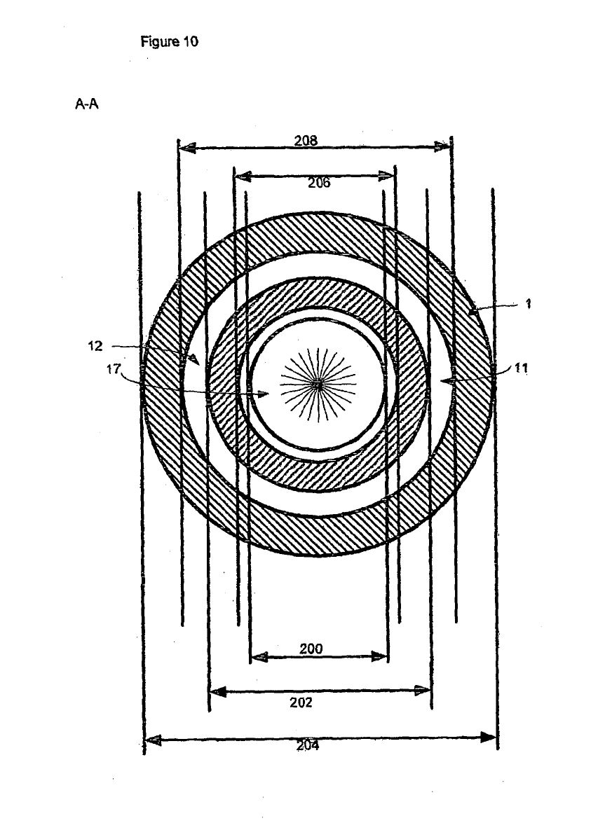

FIG. 10 shows a section A-A through the fluid disinfection apparatus shown in FIG. 1;

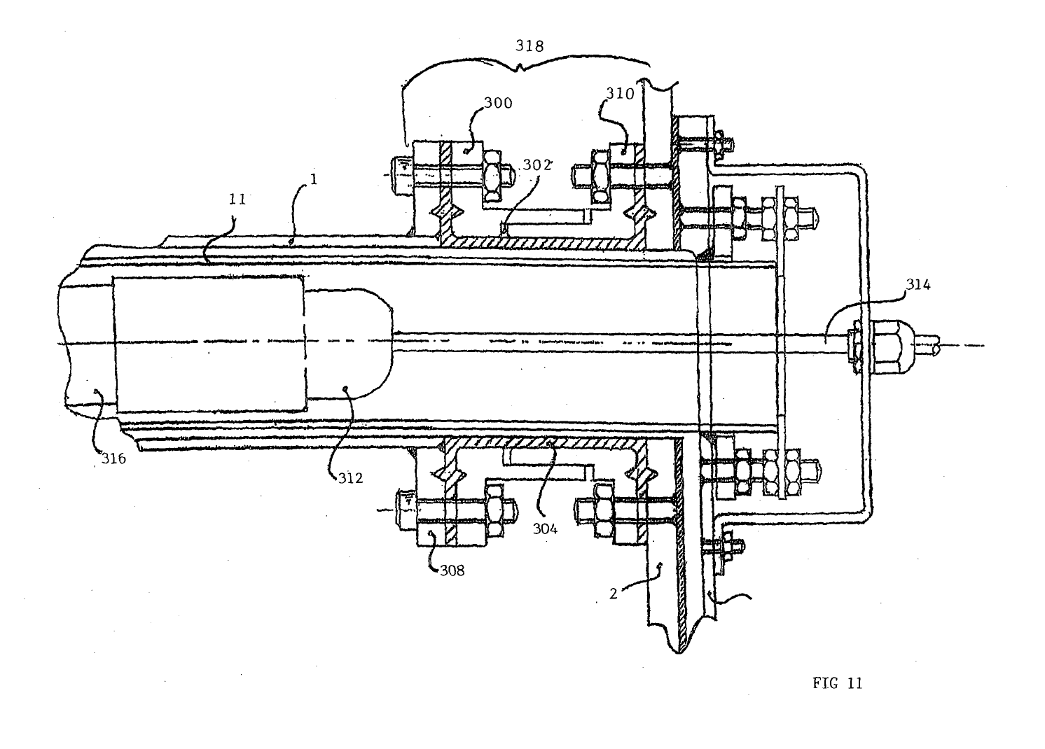

FIG. 11 shows an expansion joint for use with a fluid steriliser

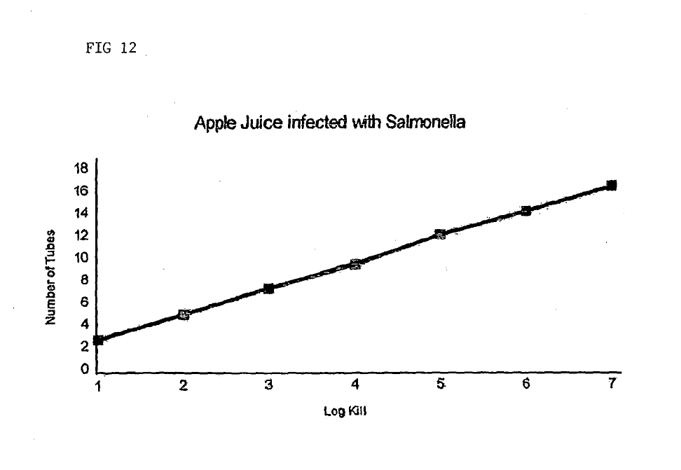

FIG. 12 shows a plot of the number of tubes against the log kill rate in apple juice infected with salmonella;

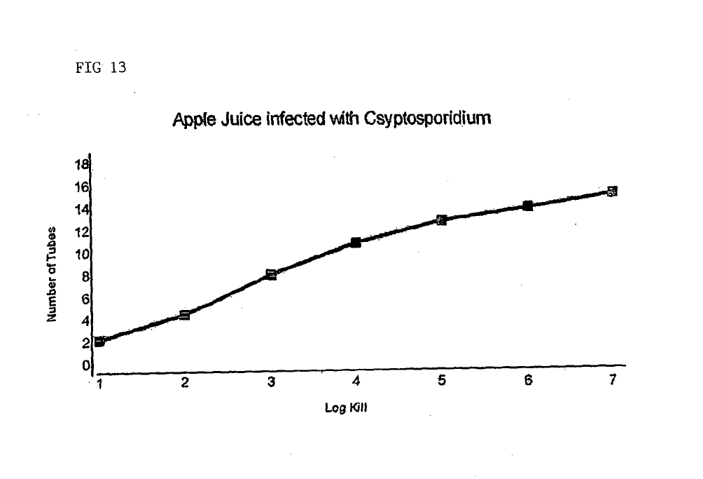

FIG. 13 shows a plot of the number of tubes against the log kill rate in apple juice infected with cysptsodoridium;

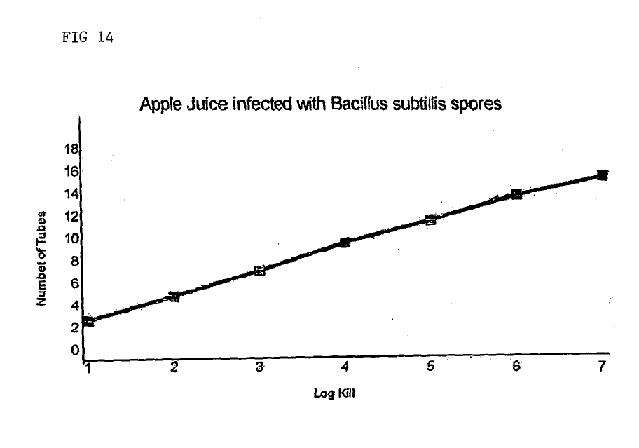

FIG. 14 shows a plot of the number of tubes against the log kill rate in apple juice infected with bacillus subtillis spores;

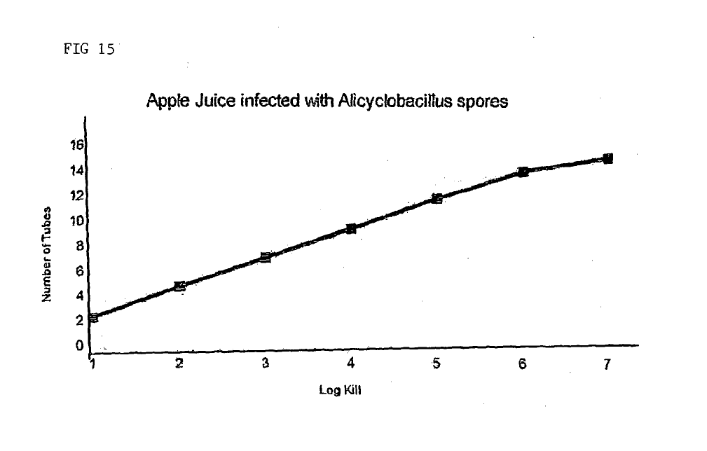

FIG. 15 shows a plot of the number of tubes against the log kill rate in apple juice infected with alicyclobacillus spores;

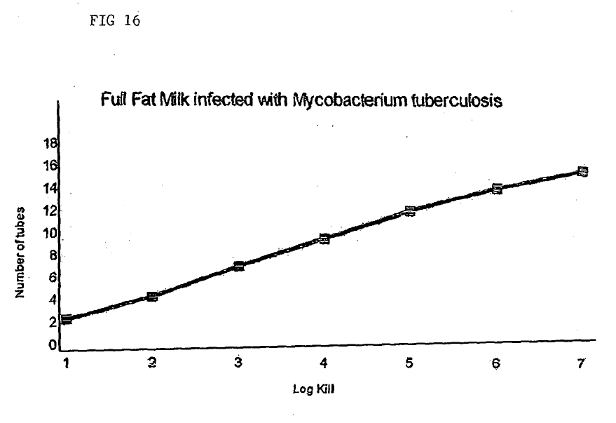

FIG. 16 shows a plot of the number of tubes against the log kill rate in full fat milk infected with Mycobacterium tuberculosis;

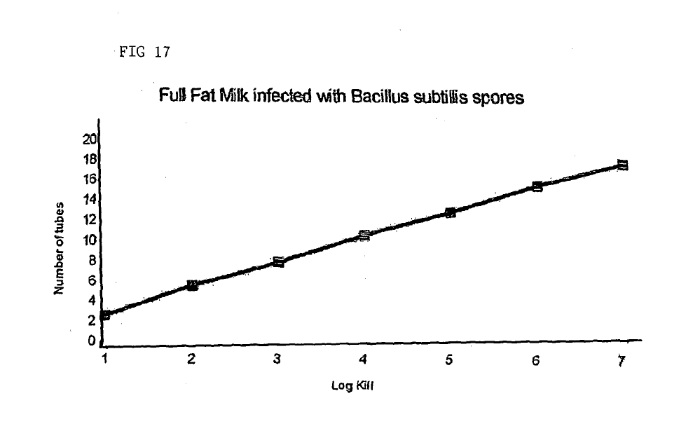

FIG. 17 shows a plot of the number of tubes against the log kill rate in full fat milk infected with bacillus subtillis spores;

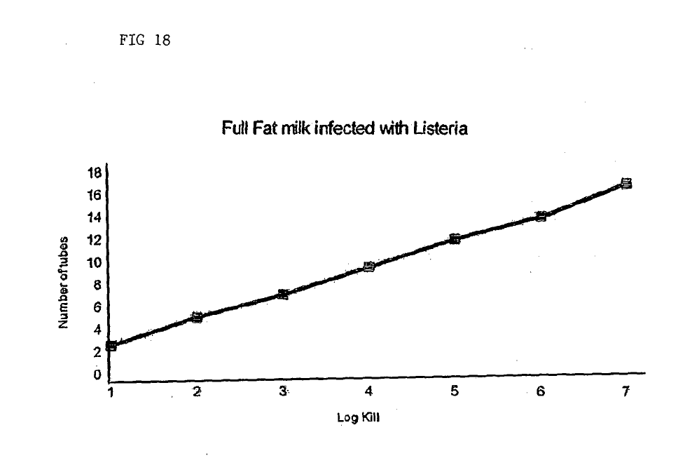

FIG. 18 shows a plot of the number of tubes against the log kill rate in full fat milk infected with listeria;

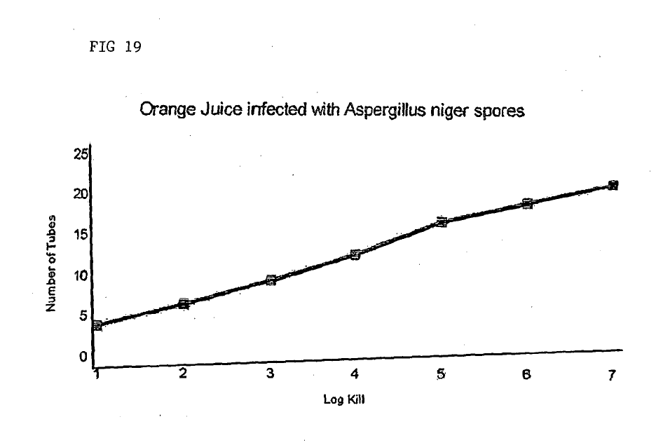

FIG. 19 shows a plot of the number of tubes against the log kill rate in orange juice infected with aspergillus niger spores;

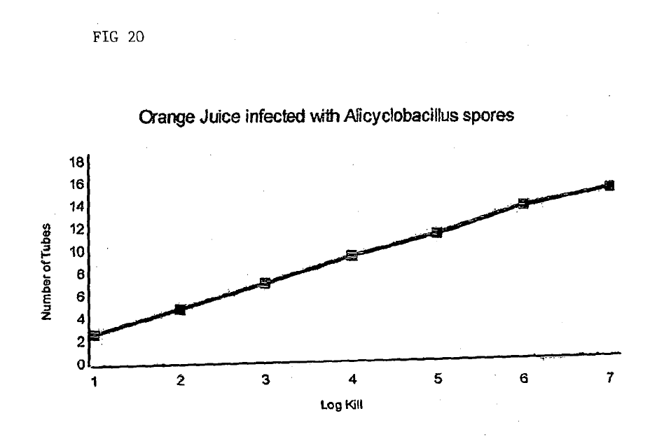

FIG. 20 shows a plot of the number of tubes against the log kill rate in orange juice infected with alicyclobacillus spores; and

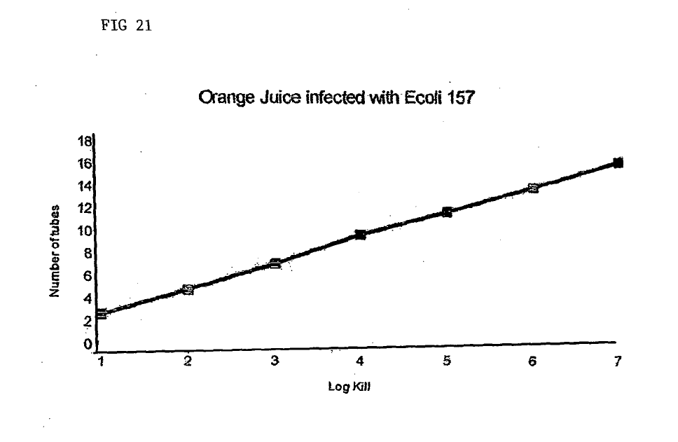

FIG. 21 shows a plot of the number of tubes against the log kill rate in orange juice infected with e coli 157;

Referring to FIG. 1 of the drawings in the first embodiment of the fluid disinfection apparatus a reaction chamber 1 is connected between end plates 2 & 3. Preferably the reaction chamber is welded to the end plates such that the welds are polished to provide a hygienic food grade seal.

Positioned adjacent to the reaction chamber is an inlet manifold 4 and an outlet manifold 5 which are attached to the end plates 2 & 3 by fastenings 6. The inlet manifold 4 and outlet manifold 5 are made watertight by seals 7 & 8 which are clamped between the inlet and outlet manifolds 4 & 5 and the end plates 2 & 3.

A tubular sleeve 11 is positioned longitudinally centrally and concentrically inside the reaction chamber 1 such that it protrudes through the end plates 2 & 3 and through the holes 9 & 10 in the inlet and exit manifolds 4 & 5.

Preferably the tubular sleeve is a good transmitter of the germicidal wavelengths (220 nm-280 nm).

Preferably the tubular sleeve is made of quartz.

Preferably the quartz sleeve is coated with a material which substantially transmits the germicidal wavelengths.

Preferably the coating material is substantially resilient in nature and is able to contain all quartz debris in the event of the quartz tube rupturing.

Preferably the material is Teflon FEP.

Means are provided to form a small concentric gap 12 between the tubular sleeve 11 and the inside wall of the reaction chamber. By selecting the dimensions of the outer diameter of the tubular sleeve 11 to be slightly smaller than the inner diameter of the reaction chamber 1, the gap 12 produced is the dimensional difference between the two.

Means are provided to make a water tight seal between the tubular sleeve 11 and the inlet and outlet manifolds 4 & 5 in the form of a seal 13 & 14 positioned on the circumference at each end of the tubular sleeve 11 adjacent to the holes 9 & 10 in the inlet and outlet manifolds 4 & 5. The seal is compressed by clamping plates 15 & 16 forming a watertight seal between the inlet and outlet manifolds 4 & 5 and the tubular sleeve 11.

The reaction chamber 1, tubular sleeve 11 and the inlet and outlet manifolds 4 & 5 form a watertight assembly such that liquid can flow in through the inlet manifold 4, through the gap 12 and out through the outlet manifold 5.

Preferably the seals 13 & 14 are made of UV resistant material.

Preferably the material is silicone rubber, Viton, PTFE or Teflon FEP.

Preferably the seals 13 & 14 are designed to be flexible such that any differential expansion between the body of the reaction chamber 1 and the tubular sleeve 11 is accommodated whilst the seals 13 & 14 still remain sealed.

Means are provided to radiate UV germicidal wavelengths (220 nm-280 nm) into the gap 12 in the form of a UV lamp 17 positioned inside the tubular sleeve 11 which when energised radiate germicidal wavelengths into the gap through the wall of the tubular sleeve 11.

Preferably the lamp 17 is positioned longitudinally centrally and concentrically inside the tubular sleeve 11 to provide consistent and even radiation into the gap 12.

Means are provided to mix the liquid as it passes through the disinfector in the form of mixing devices 18 positioned along the body of the reaction chamber 1 whereby the flow in the gap 12 is diverted into and through the mixing device 18. The mixing device 18 forces the liquid to traverse a flow path which causes it to change direction and hence velocity to create a thorough mixing of the fluid as it passes through the device.

Preferably the mixing device 18 has no moving parts.

Preferably the mixing device 18 forces the liquid into at least one 180 degree bend.

Preferably the mixing device 18 is made of material which is substantially resistant to germicidal radiation.

Preferably the outside body of the mixing device 18 is made of a food grade standard material.

Preferably the outside body of the mixing device 18 is made of 316 grade stainless steel.

Preferably the internal materials of the mixing device 18 are made of PTFE or Teflon FEP or another suitable material.

The general fluid flow is shown by the arrows A & B and the intervening arrows. Referring to FIG. 5 of the drawings shows a mixing device for the apparatus comprising circular flanges 2 & 3 attached to the body of the reaction chamber 1.

Flange 2 has shallow grooves cut into its face which act as channels for the liquid. The top groove 4 rises vertically from the centre of the flange 2 then moves in an arc in a clockwise direction for a distance around the top face of the flange 2. The bottom groove 5 falls vertically from the centre of the flange 2 then moves in an arc in a clockwise direction for a distance around the bottom face of the flange 2.

Flange 3 has a mirror pattern of grooves (not shown) cut into its face such that the grooves match each other when the flanges are fastened together.

Positioned through the centre of the reaction chamber 1 is the tubular sleeve 11 as described previously, which with the reaction chamber 1 provides the gap 12. Interposed between the two flanges is a disc 6 which has a series of holes 7 & 8 positioned so that they line up with the ends of the clockwise arcs in the two flanges 2 & 3 when the mixing device is assembled. The centre hole 10 in the disc 6 is a tight fit on the tubular sleeve 11. When the mixing device is assembled the disc 6 substantially acts as a deflector for the liquid in the gap 12 diverting it out of the gap 12 and into the grooves 4 & 5 and holes 7 & 8.

Assuming that the liquid is moving from right to left in gap 12 of the reaction chamber 1, the disc will force the liquid into the grooves 4, in flange 2, through the holes 7 & 8 in the disc 6 and back along the mirrored grooves in flange 3 and into the gap 12 in the reaction chamber 1.

A flow schematic sketch 9 shows the fluid path through the device.

The liquid will have had three complete reversals of flow through the mixing device. A—90 degree change in direction from the gap 12 to the vertical groove on flange 2, B—90 degree change in direction from vertical groove on flange 2 to the clockwise arc on flange 2, C—90 degree change in direction from the clockwise arc on flange 2 to the holes 7 in the disc 6, D—90 degree change in direction from the holes 7 in the disc 6 into the mirrored arc in flange 3, E—90 degree change in direction from the mirrored arc in flange 3 to the mirrored vertical groove in flange 3, F—90 degree change in direction from the mirrored vertical groove in flange 3 to the gap 12.

Preferably the disc is made of a UV resistant material.

Preferably the disc is made from PTFE or Teflon FEP.

The mixing device has an additional feature in that after CIP (clean in place—the drinks industry standard cleaning process) the unit self sterilizes if at the end of the cleaning cycle it is filled with water and the lamp is switched on for a period of time, there is enough radiation to reflect through the mixing device to disinfect it.

FIG. 5 only shows one disc 6 but a plurality of discs can be positioned in series to increase the level of mixing of the fluid. Those skilled in the art will appreciate that the mixing effect can be accomplished with many different labyrinths like patterns in the mixing device of which the general theory of the invention covers.

Referring to FIG. 2 of the drawings there is shown a second embodiment of a mixing device apparatus comprising a plurality of fluid disinfection apparatuses as described previously but whose inlet and outlet manifolds 5 & 6 act as conduits to allow the fluid disinfection apparatus to be connected in series.

Fluid flows from A into the gap 12 and then into the first mixing device 18 in the first fluid disinfection apparatus and continues along the gap 12 and through each mixing device 18 in turn until it flows into the exit manifold 5. The fluid then flows through the exit manifold 5 and into the gap 12 of the second fluid disinfection apparatus and the then flows in turn through each mixing device 18 in the second fluid disinfection apparatus until it reaches the second fluid disinfection apparatus's exit manifold 19.

The process repeats for as many fluid disinfection apparatuses are connected together. As the fluid passes through the gap 12 it is irradiated by the germicidal wavelengths radiating from the UV lamp 17 and through the wall of the tubular sleeve 11 to provide a very effective disinfection of the fluid film.

Several of these fluid disinfection apparatus arrays can be connected together in parallel to increase the flow handling capability of the system.

Referring to FIG. 3 of the drawings showing the third embodiment of the fluid disinfection apparatus, a plurality of fluid disinfection apparatuses are constructed such that the fluid disinfection apparatuses are connected in series. Each fluid disinfection apparatus feeds it flow into another fluid disinfection apparatus.

Each fluid disinfection apparatus consists of a reaction chamber 1 rigidly connected between end plates 2 & 3. Preferably the reaction chamber is welded to the end plates such that the welds are polished to provide a hygienic food grade seal.

Positioned adjacent to the reaction chamber is an inlet manifold 4 and an outlet manifold 5 which are attached to the end plates by fastenings 6. The inlet manifold 4 and outlet manifold 5 are made watertight by seals 7 & 8 which are clamped between the inlet and outlet manifolds 4 & 5 and the end plates 2 & 3.

A tubular sleeve 11 is positioned longitudinally centrally and concentrically inside the reaction chamber such that it protrudes through the end plates 2 & 3 and through a hole 9 in the inlet manifold 4.

Preferably the tubular sleeve is a good transmitter of the germicidal wavelengths (220 nm-280 nm).

Preferably the tubular sleeve is made of quartz.

Preferably the tubular sleeve is closed at one end 28.

Preferably the quartz sleeve is coated with a material which substantially transmits the germicidal wavelengths (220 nm-280 nm).

Preferably the coating material is substantially resilient in nature and is able to contain all quartz debris in the event of the quartz tube rupturing.

Preferably the material is Teflon FEP.

Means are provided to form a small concentric gap 12 between the tubular sleeve 11 and the inside wall of the mixing sleeve 20. By selecting the dimensions of the outer diameter of the tubular sleeve 11 to be slightly smaller than the inner diameter of the mixing sleeve 20, the gap 12 produced is the dimensional difference between the two.

Means are provided to make a water tight seal between the tubular sleeve 11 and the inlet manifold 4 in the form of a seal 13 positioned on the circumference of the open end of the tubular sleeve 11 adjacent to a hole 9 in the inlet manifold. The closed end of the tubular sleeve 11 is supported by collar 21 and it is free to move inside the collar.

Any differential expansion between the reaction chamber 1 and the tubular sleeve 11 is automatically accommodated by this arrangement.

Under fluid pressure the tubular sleeve 11 with one end closed experiences a net force which acts such as to move the tubular sleeve 11 in the direction of the open end of the tube. To prevent tubular sleeve 11 movement under pressure the retaining plate 22 holds the tubular sleeve 11 in position preventing any movement.

The seal 13 is compressed by a clamping plate 15 forming a watertight seal between the inlet manifold 4 and the tubular sleeve 11. The reaction chamber 1, tubular sleeve 11 and the inlet and outlet manifolds 4 & 5 form a watertight assembly such that fluid can flow in through the inlet manifold 4, through the gap 12 and out through the outlet manifold 5.

Preferably the seal 13 is made of UV resistant material.

Preferably the material is silicone rubber, PTFE or FEP or another UV resistant material. Means are provided to radiate UV germicidal wavelengths (220 nm-280 nm) into the gap 12 in the form of a lamp 17 positioned inside the tubular sleeve which when energised radiate germicidal wavelengths into the gap through the wall of the tubular sleeve.

Means are provided for mixing the liquid in the gap 12 in the form of a mixing sleeve 20 which is rigidly fixed in a watertight manner into the reaction chamber 1. Preferably the mixing sleeve is pressed or glued onto the reaction chamber 1 forming a water tight seal. Preferably in order to provide an additional mixing function to the fluid film, the inside surface of the mixing sleeve 20 adjacent to the tubular sleeve 11 is formed into a pattern which when the liquid flows through the gap 12 creates turbulence and hence mixing in the fluid film.

Preferably the lamp is positioned longitudinally centrally and concentrically inside the tubular sleeve to provide consistent and even radiation into the gap.

Means are provided to mix the fluid as it passes through the disinfector in the form of mixing devices 18 positioned along the body of the reaction chamber whereby the flow in the gap 12 is diverted into and through the mixing device. The mixing device 18 forces the fluid flow to traverse a path which causes the fluid to change direction and hence velocity to create a thorough mixing of the fluid as it passes through the device.

Preferably the mixing device 18 has no moving parts.

Preferably the mixing device 18 is made of material which is substantially resistant to germicidal radiation.

Preferably the mixing device 18 is made of a food grade standard material.

Preferably the body of the mixing device 18 is made of 316 standard stainless steel.

Preferably the internal parts of the mixing device 18 are made of PTFE, Teflon FEP or another suitable material.

Means are provided to add additional mixing in the form of a propeller 23 positioned through the wall of each of the inlet and outlet manifolds. The motor and gearbox 24 is fixed to the wall of each of the inlet and outlet manifolds and is supported by a bearing and seal 27.When actuated by the motor and gearbox 24 the propeller 23 rotates in the fluid flow and creates a high level of mixing.

The fluid to be disinfected enters into the apparatus via the inlet pipe 26 through the wall of the feed manifold 25

The general fluid flow is shown by the arrows A, B, C & D. Referring to FIG. 4 of the drawings shows a mixing device for the apparatus comprises circular flanges 2 & 3 attached to the body of the reaction chamber 1. Both flange 2 and flange 3 have smooth faces

Positioned through the centre of the reaction chamber 1 is the tubular sleeve 11 as described previously, which with the reaction chamber 1 provides the gap 12.

Interposed between the two flanges is a plurality of discs 6 each disc has a series of slots 7 cut into the disc 6 radially from the centre outwards and positioned equi-distance around the circumference of the disc 6. Each disc 6 is positioned so that the slots in alternative discs are equi-spaced between the slots in the proceeding disc 6 such when the discs 6 are assembled together they form a labyrinth i.e. there is no straight fluid path through the assembled discs. Preferably the disc patterns are made and assembled such that the resulting labyrinth causes a fluid flowing through it to be forced to perform 180 degree bends. The centre hole 10 in the disc 6 is a tight fit on the tubular sleeve 11 which when the mixing device is assembled the walls 9 of the disc 6 substantially acts as a deflector for the fluid diverting it out of the gap 12 and forcing it through the slots 7 and through the labyrinth.

Preferably the fluid will have had many complete reversals of flow through the mixing device creating a thorough mixing of the fluid.

Preferably the discs 6 are made of a UV resistant material.

Preferably the disc is made from PTFE or Teflon FEP.

The mixing device has an additional feature in that after CIP (clean in place—the drinks industry standard cleaning process) the unit self sterilizes if at the end of the cleaning cycle if it is filled with water and the lamp is switched on for a period of time, there is enough radiation to reflect through the mixing device to disinfect it.

FIG. 4 only shows three discs 6 but a plurality of discs can be positioned in series to increase the level of mixing of the fluid. Those skilled in the art will appreciate that the mixing effect can be accomplished with many different labyrinth-like patterns in the mixing device of which the general theory of the invention covers.

It should be noted that known static mixers do not create flow reversal i.e. 180 degree bend: they blend a liquid by manipulating it always in a forward direction and hence need a sizable longitudinal component to effect the mixing. The mixing devices in this invention effect the mixing over a short distance by flow reversal and hence a plurality of mixing devices can be employed over a short distance.

Referring to FIGS. 6 and 7 of the drawings, a fluid treatment system comprises a plurality of fluid treatment apparatus 99 of the kind disclosed in FIG. 1 mounted side-by-side in a housing 105. Each apparatus 100 comprises an elongate tubular duct 100 having a fluid inlet and outlet 101,102 at opposite ends thereof, an elongate source of UV radiation 104 extending longitudinally of the elongate tubular duct 100. A plurality of mixing devices 103 of the kind disclosed in FIG. 4 or 5 are disposed between adjacent longitudinal portions of each duct 100 for diverting the fluid flowing along the duct through fluid mixing formations in the device 103 and for returning the mixed fluid to the duct.

The outlet and inlets 101, 102 of adjacent apparatus 99 are connected to each other via respective manifolds 106. In use, fluid flows downwardly from an inlet duct 107 into the first apparatus 100 and then through a manifold 106 and upwardly through a second apparatus 100 and so on until the fluid flows out of the last apparatus 99 into an outlet duct 108.

Referring to FIG. 8 of the drawings, a fluid treatment comprises an elongate tubular duct 110 having an elongate source of UV radiation 111 extending longitudinally of the elongate tubular duct 110. A plurality of mixing devices 112 are sealingly fitted between disposed between adjacent longitudinal portions the duct 110 for diverting all of the fluid flowing along the duct 110 through fluid mixing formations 113 in the device 112 and for returning the mixed fluid to the duct 110.

Each device 112 depends from the duct 110 and is mounted entirely below the level of the flow passage 114 therein to ensure that no high spots exist in which air may become trapped. The device 112 comprises a flow path having an inlet duct 115 which extends perpendicular to the longitudinal flow axis of the passage 114. The path then comprises a series of formations 113 which turn the fluid flow through 180[deg.] and direct it at a baffle wall where it is deflected into another formation 113 ensuring that the fluid is thoroughly mixed. Fluid then leaves the device 112 through a flow an outlet duct 117 which extends perpendicular to the longitudinal flow axis of the next section of the passage 114.

The formations 113 are formed in the opposing faces of plates 118,119 which are clamped together against a central plate 120 formed with apertures 121 that communicate between the formations 113. The plate 120 and or plates 119,120 may be formed of a material which transmits UV radiations so that the flow path is sterilised by the radiation from the UV source 111.

Referring to FIG. 9 of the drawings, there is shown an embodiment which is similar to the embodiment of FIG. 8 but which is simpler in construction.

The presention disclosure thus provides a fluid treatment apparatus particularly for sterilising drinks which comprises an elongate tubular duct and an elongate UV light source extending longitudinally of the duct. A mixing device disposed between adjacent longitudinal portions of the duct diverts all of the fluid flowing along a first portion of the duct through fluid mixing means in the device and returns the mixed fluid to a second portion of the duct. The fluid flows longitudinally of the duct in a thin annular low passage which extends around the UV light source. Micro-organisms in the resultant thin flow of fluid are killed as they come within close proximity of the light source. The mixing device causes all of the flow to be thoroughly mixed and returned to the flow passage. The preferred provision of a plurality of mixing devices along the length of the duct increases the likelihood that all microorganisms receive a sufficient lethal dose of UV radiation.

Our earlier work showed that pasteurization (in excess of 5 log kill or 99.999% kill) could be achieved on a thin film of various drinks and liquids. A range of comestible fluids have now been tested (selected to be a representative sample of those found on supermarket shelves) including the most dense, opaque liquids such as concentrated blackcurrant juice.

Testing for transmissivity was performed using concentrated blackcurrant juice using a film thickness of 0.25 mm. The UV transmissivity of concentrated blackcurrant juice over this distance was found to be 0.13%. In this example the transmissivity of a liquid is described as the ratio of light radiation intensity lost at a given wavelength per unit distance travelled through the liquid.

Transmissivity is therefore described in mathematical terms as a geometric progression and follows the formula;

Transmissivity T=n−1 √(I/Io)
Where n=the number of terms in the expression
I=the light intensity emerging from the 0.25 mm liquid film
Io=the light intensity at the surface of the liquid

We have recognised that, in UV disinfection, transmissivity is very important and probably has the most modifying effect on dose received by liquids in a disinfection apparatus.

Our previous work on the UV disinfection of sewage showed that, if turbulence was introduced into the liquid the microbiological kill rate was significantly increased. It was thought that this increase occurred because more of the liquid is exposed to the UV radiation. It is important to note that the early M Snowball thin film tests were carried out on a thin film without any film turbulence.

If a thin film of say 2.5 mm thick is exposed to UV light then the first 0.25 mm of the liquid nearest the lamp will be disinfected as the light can penetrate this far into the liquid. If this 2.5 mm film is then thoroughly mixed and then exposed to the UV light again a new 2.5 mm film is formed and hence a new 0.25 mm film is produced nearest the lamp. Each liquid will have a different optical density to the UV wavelength and therefore the rates of disinfection liquid to liquid will vary.

On average the new 0.25 mm film will be composed of 90% new none-disinfected liquid and 10% disinfected liquid as there are 10×0.25 mm films in a 2.5 mm film. If this technique is repeated the microbiological disinfection rate of the liquid would be expected to rise towards total pasteurization at 5.5 log kill in a predictable fashion. However, we have now provided surprising increases in the rate of disinfection from repeated UV exposure which far exceed the predicted trend.

FIG. 10 shows a section A-A through the fluid disinfection apparatus shown in FIG. 1. As shown the source of UV light in FIG. 10 is an amalgam lamp 17 having an outer diameter 200. The UV transmissive tubular sleeve 11 has an interior diameter 206 and an exterior diameter 202. The outer sleeve 11 has an interior diameter 208 and an exterior diameter 204. The gap between the UV transmissive tubular sleeve 11 and the outer tubular sleeve 1 provides a tubular duct 12 for the flow of a fluid. The duct has a radial extent defined by the distance between the exterior surface of the UV transmissive sleeve and the interior surface of the outer sleeve.

The duct provides a linear path for substantially laminar flow of the fluid between mixing devices. This laminar flow of fluid is pumped along the duct with a linear speed set by the volume flow rate and the cross section of the duct. The substantially laminar flow is directed along a path which is substantially parallel with the axis of the tubular duct. Mixing devices such as the baffles 9 (shown in FIG. 5) are distributed at evenly spaced intervals along the duct and are arranged substantially perpendicular to the direction of fluid flow. The fluid flow (along the duct or elsewhere) need not be laminar and in some examples may be partially or fully turbulent.

Table 1 details examples of disinfections performed using this apparatus. In these examples a process module was employed having 20 UV tube/duct arrangements coupled together in series. Each tube had nine mixing devices 18 positioned equidistantly along its length. Each mixing device 18 was separated from its neighbour by a fixed spacing, one tenth the length of the tube. In this way each fluid sample experienced nine mixing steps per tube and so ten UV irradiations per tube and 180 mixes and 200 irradiations per module. Fluid was passed through the module at a rate of 3,000 litres per hour.

The liquid used was full fat milk infected with bacillus subtilis spores.

TABLE 1

| | | | | Duct | | | | Number |
|---|---|---|---|---|---|---|---|---|
| | | Chamber | Pressure | cross | linear | | Tubes for | of |
| | Lamp Sleeve | diameter | Drop | section | speed | Dose | >5 log | 0.25 mm |
| | Diameter (cm) | (cm) | (bar) | (cm²) | (ms⁻¹) | (mJ/cm²) | kill | films |
| 1 | 3.9 | 4.75 | 0.2 | 5.77 | 1.44 | 257 | 12 | 17 |
| 2 | 4.0 | 4.495 | 1.0 | 3.30 | 2.52 | 117 | 12 | 10 |
| 3 | 4.0 | 5.0 | 0.16 | 7.07 | 1.18 | 250 | 12 | 20 |
| 4 | 4.2 | 5.2 | 0.148 | 7.38 | 1.13 | 181 | 12 | 20 |
| 5 | 4.4 | 5.4 | 0.13 | 7.70 | 1.08 | 142 | 12 | 20 |
| 6 | 4.6 | 5.251 | 0.3 | 5.04 | 1.65 | 74 | 12 | 13 |
| 7 | 5.0 | 5.479 | 0.6 | 3.94 | 2.11 | 40.9 | 14 | 9 |

### EXAMPLE 1

In Example 1 a UV transmissive lamp sleeve 11 having an outer diameter 200 of 39 mm was used with an outer sleeve 1 having an internal diameter 208 of 4.75 cm to provide a tubular duct having a radial extent of 4.25 mm and a total cross sectional area of 5.77 cm². The linear speed of fluid in the duct was approximately 1.44 ms⁻¹.

This configuration produces a relatively large energy dose of 257 mJ/cm² and relatively high linear speed.

### EXAMPLE 2

In Example 2 the UV transmissive lamp sleeve 11 had an outer diameter 200 of 40 mm. The outer sleeve 1 had an internal diameter 208 of 44.95 mm to provide a tubular duct having a radial extent of 2.48 mm and a total cross sectional area of 3.30 cm². The linear speed of fluid in the duct was approximately 2.52 ms⁻¹.

In this configuration the linear speed of the fluid is much higher than in Example 1 and the dose per segment is much lower. This configuration produces a reasonable dose but the pressure drop along each tube is undesirably high due to the small size of the gap between the lamp sleeve and the outer tube.

### EXAMPLE 3

In Example 3 the UV transmissive lamp sleeve 11 had an outer diameter 200 of 40 mm. The outer sleeve 1 had an internal diameter 208 of 50 mm to provide a tubular duct having a radial extent of 5 mm and a total cross sectional area of 7.07 cm². The linear speed of fluid in the duct was approximately 1.18 ms⁻¹.

In this configuration the linear speed of the fluid is slightly lower than in Example 1 and the dose per segment is roughly equivalent. This achieves excellent dose in combination with a low pressure drop across the tube.

### EXAMPLE 4

In Example 4 the UV transmissive lamp sleeve 11 had an outer diameter 200 of 42 mm. The outer sleeve 1 had an internal diameter 208 of 52 mm to provide a tubular duct having a radial extent of 6 mm and a total cross sectional area of 7.38 cm². The linear speed of fluid in the duct was approximately 1.13 ms⁻¹.

In this configuration the linear speed of the fluid is slightly lower than in Example 1 and the dose per segment is roughly equivalent. It can be seen that as the lamp sleeve starts to increase the dose starts to decrease. In this examples the pressure drop is reduced because of the increased cross section of the duct. The linear speed of the fluid also drops thus increasing the retention time (dwell time in front of the lamp). However, surprisingly the dose drops off very strongly so it seems that the increase in dwell time is not sufficient to compensate for the loss in UV intensity caused by the increase in lamp sleeve diameter.

### EXAMPLE 5

In Example 5 the UV transmissive lamp sleeve 11 had an outer diameter 200 of 44 mm. The outer sleeve 1 had an internal diameter 208 of 54 mm to provide a tubular duct having a radial extent of 5 mm and a total cross sectional area of 7.7 cm². The linear speed of fluid in the duct was approximately 1.08 ms⁻¹.

### EXAMPLE 6

In Example 6 the UV transmissive lamp sleeve 11 had an outer diameter 200 of 46 mm. The outer sleeve 1 had an internal diameter 208 of 52.51 mm to provide a tubular duct having a radial extent of 3.26 mm and a total cross sectional area of 5.04 cm². The linear speed of fluid in the duct was approximately 1.65 ms⁻¹

### EXAMPLE 7

In Example 7 the UV transmissive lamp sleeve 11 had an outer diameter 200 of 50 mm. The outer sleeve 1 had an internal diameter 208 of 54.79 mm to provide a tubular duct having a radial extent of 2.4 mm and a total cross sectional area of 3.94 cm². The linear speed of fluid in the duct was approximately 1.65 ms⁻¹.

FIG. 11 shows an expansion joint for use in a fluid steriliser. The outer sleeve 1 of the steriliser houses a UV transmissive sleeve 11. A UV lamp 316 is arranged within the UV transmissive sleeve and coupled by connector 314 to the housing of the steriliser. The sleeve 1 is coupled to the end plate 2 by an expansion joint 318.

The expansion joint 318 comprises a two part support 300, 310 and an extensible and compressible sleeve 304. The first part of the support 310 is fixed to the end plate 2. The second part of the support 300 is fixed to the sleeve 1. The second part 300 of the support is configured to fit closely around the first part of the support 310 so as to be held in position and so that the first part of the support can slide into and out of the second part. The extensible and compressible sleeve 304 is coupled between the end plate 2 and a bracket 308 on the sleeve 1.

Typically the UV transmissive sleeve comprises a material such as quartz and the outer sleeve 1 comprises a material such as stainless steel. The inventors in the present case have appreciated that it is desirable to clean the apparatus using water heated to approximately 90° C. but that the thermal stresses associated with the differing thermal expansion of the sleeve and the UV transmissive sleeve may cause the unit to be cracked or damaged during cleaning.

The module was tested with apple juice, full fat milk and orange juice infected with a number of different pathogens. The results of these tests are shown in FIGS. 12 to 21 which show plots of the number of UV tubes against the log kill rates. Each test infected the relevant liquids with the named micro-organism at an inoculation of 100,000 cfu/ml.

Although described with reference to edible fluids the processes described herein may advantageously also be applied to non-edible fluids and in particular to diesel oil. Similarly, although described with reference to cylindrical geometries these are merely particularly advantageous examples and other configurations of duct and UV light source may be used.

1. A fluid steriliser comprising:
a fluid duct having a UV transmissive wall providing a surface area for irradiation, wherein the cross section of the duct is between 1×10⁻⁴ m² and 5×10⁻² m² and the thickness of the duct defines the depth of fluid flow adjacent the UV transmissive wall of no more than 50 mm;
a source of UV radiation arranged to irradiate fluid flowing in the duct through the UV transmissive wall such that the UV radiation incident on fluid in the duct has a UV power density;
a plurality of mixing stages configured to provide turbulent flow in the fluid and spaced apart along the length of the duct wherein the segments of the duct between the mixing stages are arranged to provide flow adjacent the UV transmissive wall;
a flow control means arranged to control the linear speed of fluid flow along the duct based on the length of the duct and the UV power density so that at least 300 Joules of UV energy per square metre of the surface area for irradiation is provided to the fluid during the dwell time of the fluid in the duct.

2. The fluid steriliser of claim 1 in which the mixing stages comprise UV transmissive material wherein the mixing stages are arranged so that UV light from the UV source can reach the interior surfaces of the missing stages when the mixing is filled with UV transmissive fluid.

3. (canceled)

4. The fluid steriliser of any preceding claim in which the flow control means is configured such that, in use with fluids having a viscosity of less than 200 centipoise, the pressure drop across the fluid duct is less than 8 bar.

5. The fluid steriliser of claim 1 comprising an expansion joint adapted to reduce strain on the UV transmissive wall due to thermal expansion of a wall of the duct, and in which the expansion joint comprises a holder for holding the duct and a resilient adapter coupled between the wall of the duct and the holder and arranged such that the resilient adapter is compressible or extensible to accommodate expansion or contraction of the wall of the duct with respect to the UV transmissive wall.

6. (canceled)

7. The fluid steriliser of claim 5 in which the holder comprises a ring and a collar adapted to be seated about the ring so that the transverse movement of the collar is constrained with respect to the ring.

8.-9. (canceled)

10. The fluid steriliser of claim 1 in which the flow control means is configured to control the flow of fluid along the duct such that the average linear speed of the fluid flow between the baffles is between 0.5 and 4 metres per second.

11. (canceled)

12. The fluid steriliser of claim 1 in which the duct comprises a cylindrical outer wall and a cylindrical inner wall comprising the UV transmissive wall, and the outer wall comprises stainless steel.

13. (canceled)

14. The fluid steriliser of claim 12 in which the inner wall of the duct has an internal diameter of at least 36 mm and in which the source of UV radiation comprises a tube lamp having an outer diameter of no more than 34 mm.

15. (canceled)

16. A fluid steriliser comprising a duct having a UV transmissive wall and a second wall, wherein the coefficient of thermal expansion of the second wall is different from the coefficient of thermal expansion of the UV transmissive wall and in which the steriliser comprises a movable means configured to be moved to accommodate thermal expansion or contraction of the walls.

17. The fluid steriliser of claim 16 in which the movable means comprises an expansion joint in at least one of the second wall and the UV transmissive wall.

18. The fluid steriliser of claim 16 in which the expansion joint comprises an extensible member arranged to be extended or compressed along a direction of expansion and a support arranged to provide free play in the direction of expansion and to support the at least one of the second wall and the UV transmissive wall.

19. The fluid steriliser of claim 18 in which the support comprises a shoulder and a cover coupled to the shoulder by the extensible member and arranged to cooperate with the shoulder to support the at least one of the second wall and the UV transmissive wall.

20. A fluid treatment apparatus comprising a plurality of mutually similar units, each unit comprising plurality of elongate tubular ducts and a fluid inlet in fluid communication with a fluid outlet via the plurality of elongate tubular ducts, each duct having:
a UV transmissive inner wall spaced from an outer wall to enable fluid flow along the tubular duct between the inner wall and outer wall;
a plurality of baffles distributed along the length of the duct and arranged substantially perpendicular to the direction of the fluid flow;
the apparatus further comprising a flow control means configured to control the flow of fluid along the duct such that the average linear speed of the fluid flow between the baffles is between 0.8 and 1.6 meters per second.

21. The apparatus of claim 20 in which the flow control means is configured to control the flow of fluid such that the average linear speed of the fluid flow between the baffles is between 1.0 meters per second and 1.4 metres per second.

22. The apparatus of claim 20 in which the fluid inlet of each unit of the plurality of mutually similar units is coupled to a common fluid source and the fluid outlet of each unit of the plurality of mutually similar units is coupled to a common fluid sink such that the units are arranged to process fluid in parallel.

23. The apparatus of claim 20 in which, in each unit, the plurality of elongate tubular ducts are arranged in series.

24. (canceled)

25. The apparatus of claim 20 in which the interior surface of the inner wall of the duct has a diameter of at least 38.5 mm, preferably at least 39 mm, still more preferably at least 39.5 mm.

26. The apparatus of claim 20 in which the interior surface of the outer wall of the duct has a diameter of less than 54 mm, preferably less than 52 mm, still more preferably less than 51 mm.

27. A method of disinfecting comestible fluid comprising providing fluid into a fluid treatment apparatus comprising an elongate tubular duct having:
duct inlet, a duct outlet, and a UV transmissive inner wall spaced from an outer wall to enable fruit juice to flow along the tubular duct between the inner wall and outer wall, wherein the cross section of the duct through which fluid can flow has an area of at least 1×10⁻⁴ m² and less than 1×10⁻³ m²; a plurality of baffles distributed along the length of the duct and arranged at an angle of at least 70° to the direction of the flow;
irradiating the fluid through the UV transmissive wall with UV radiation;
controlling the pressure of the juice such that the pressure difference between the duct inlet and the duct outlet is less than 0.4 bar and more than than 0.05 bar.

28. The method of claim 27 in which the fluid is one of milk, edible oil, vinegar, beer and fruit juice.

29.-40. (canceled)
